(19) United States
(12) Patent Application Publication
(10) Pub. No.: US 2010/0096220 A1
(43) Pub. Date: Apr. 22, 2010

(54) STACKABLE FRAME DUMBWAITER

(76) Inventors: John B. Reite, Georgetown, CA (US); John D. Reite, Georgetown, CA (US)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/254,389

(22) Filed: Oct. 20, 2008

(51) Int. Cl. B66B 11/04

(52) U.S. Cl. 187/251

(57) ABSTRACT

A dumbwaiter used in building structures that have a structural vertical shaft where lower and upper with one or more middle frame assemblies are mounted against an interior wall defining a continuous track inside said through opening. A motor with controls is housed within the lower frame assembly and includes a driving sprocket. The upper frame assembly includes a driven sprocket and a chain trained over them is moved. A trolley or carrier slidably runs over track and rails continuously disposed within the frame assemblies and engage to the chain for vertical movement between two extreme positions. The motor is controlled with remotely positioned inputs either through wire or wirelessly. Safety sensors interrupt the output signal to the motor if certain events occur.

### BACKGROUND OF THE INVENTION

1. Field of the Invention

The present invention relates to a stackable frame dumbwaiter, and more particularly, to the type that is pre-fabricated and ready for on-site assembly.

2. Description of the Related Art

Several designs for dumbwaiters have been designed in the past. None of them, however, includes an approach for the installation of a system of pre-wired stackable frames that include the complete drive assembly for the dumbwaiter, and the track and rail assembly for the dumbwaiter on telescopically stackable frames along one plane only, using a vertical wall for support.

Applicant believes that the closest reference corresponds to U.S. Pat. No. 6,167,670 B1 previously issued to the applicant for a casing system for dumbwaiters on Jan. 2, 2007. Similar to the patented dumbwaiter, the present invention is stackable and prefabricated for easy and quick installation on the job site. However, the Applicant believes the present invention to be a novel improvement over the previously patented invention. The present invention has eliminated the shaft casing, which is a costly component, and can be installed in any pre-existing shaft. The frames are mounted against a vertical structure (typically a wall). This results in volumetrically efficient storage and transportation, in addition to being easier to install. In order to further decrease the assembly time, the present invention also comes pre-wired and with the track assemblies fixed to the stackable frames. The volumetrically efficient storage characteristics of the system are quite desirable features.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a volumetrically efficient system of stackable frames that includes the complete drive assembly for the dumbwaiter mounted to the stackable frames mounted against a vertical structure.

It is another object of this invention to provide a system of stackable frames with the track assembly completely assembled and pre-mounted to the frame.

It is still another object of the present invention to provide a frame only assembly capable of being disassembled into easy to handle frames that can be reassembled at the job site to form a continuous vertical path along which a dumbwaiter is raised and lowered.

It is yet another object of this invention to provide a versatile pre-wired stackable frame assembly that can be adapted to different dimensions within a reasonable range.

It is yet another object of this invention to provide a system of stackable frames that can be readily assembled at the job site in a relatively short period of time without requiring special tools.

It is yet another object of this invention to provide such a system that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an elevational view of a dumbwaiter system incorporating the present invention.

FIG. 1A is a block diagram representation of the electrical circuit used in the embodiment shown in FIG. 1.

FIG. 2 shows an elevational view of a collapsed dumbwaiter system in storage or transportation.

FIG. 3 illustrates an isometric view of the lowermost frame and the motor drive assembly.

FIG. 3A is a bottom view of frame assembly 20.

FIG. 3B is a partial cross-sectional view taken along line 3B in FIG. 3.

FIG. 4 is a partial isometric view of two connection frame corners.

FIG. 5 is an enlarged bottom view of the upper frame taken along line 5-5 in FIG. 1.

### DETAILED DESCRIPTION OF THE INVENTION

Referring now to the drawings, where the present invention is generally referred to with numeral 10, it can be observed that it basically includes lower frame assembly 20, middle frame assembly 40, and upper frame assembly 60 that are continuously stackable, one on top of the other one, defining a continuous frame.

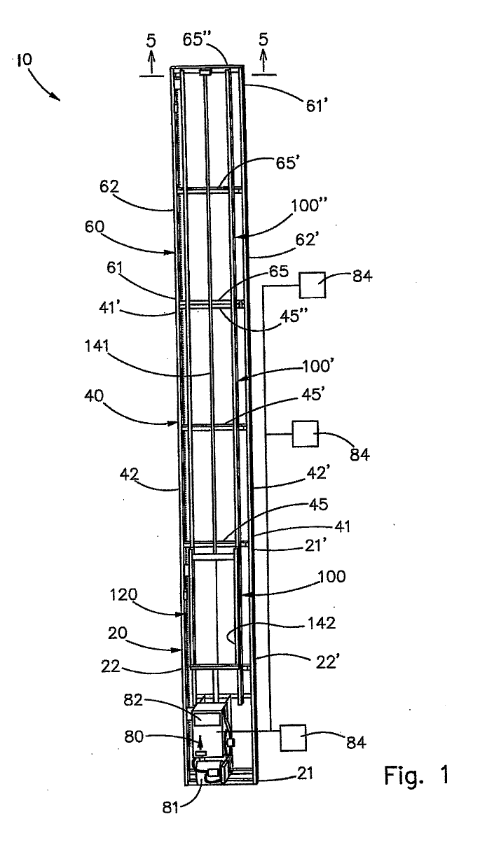

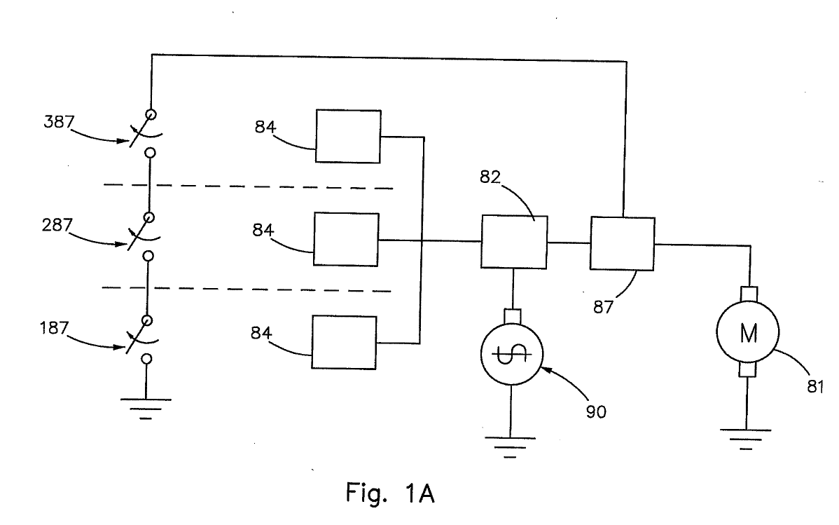

Electric motor assembly 80 is mounted adjacent to assembly 20 and includes motor 81 and control circuit assembly 82 that in the embodiment is computerized. Input circuit assemblies 84 each include one or more switches for the operation of control circuit assembly 82. Typically, there is one assembly 84 per floor. In FIG. 1 and 1A, three assemblies 84 are represented that can be used, one for each floor. Assembly 82 includes a suitable (relay) connection to electric power source 90 to activate motor assembly 81 through safety circuit assembly 87. Assembly 87 selectively interrupts the electrical connection between assembly 82 and motor assembly 81 upon the occurrence of predetermined events. For example, if the doors (not shown) in a dumbwaiter assembly are open, the operation of the system is disabled. As seen in FIG. 1A, switches 187; 287; and 387 in each floor are connected in series and adapted to open in the event one or more of the doors to the shaft is open, sending a signal to control circuit assembly 82 that is a required condition for the operation of motor assembly 81.

Stackable frame dumbwaiter 10 also includes track assemblies 100; 100′; and 100″, which are interiorly mounted to frame assemblies 20; 40; and 60, respectively. Wiring assembly 120 runs longitudinally along track assemblies 100; 100′; and 100″, as seen in FIG. 1.

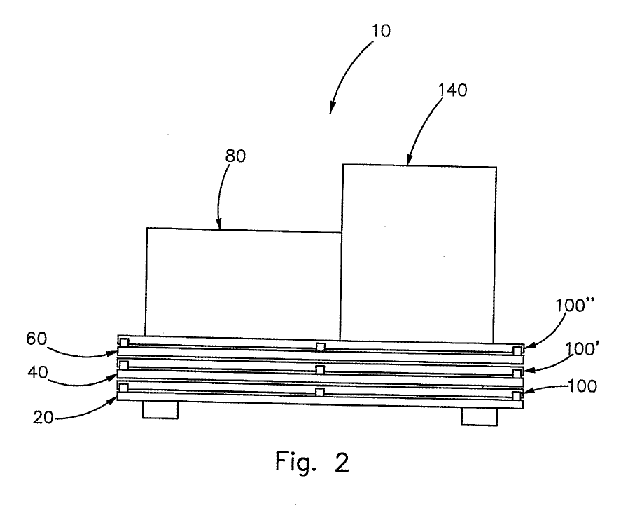

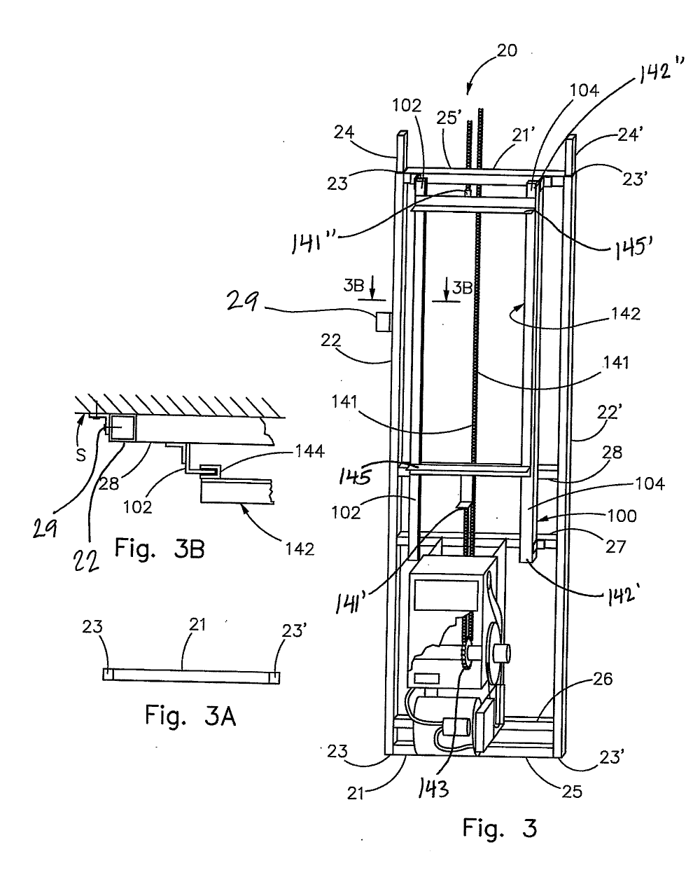

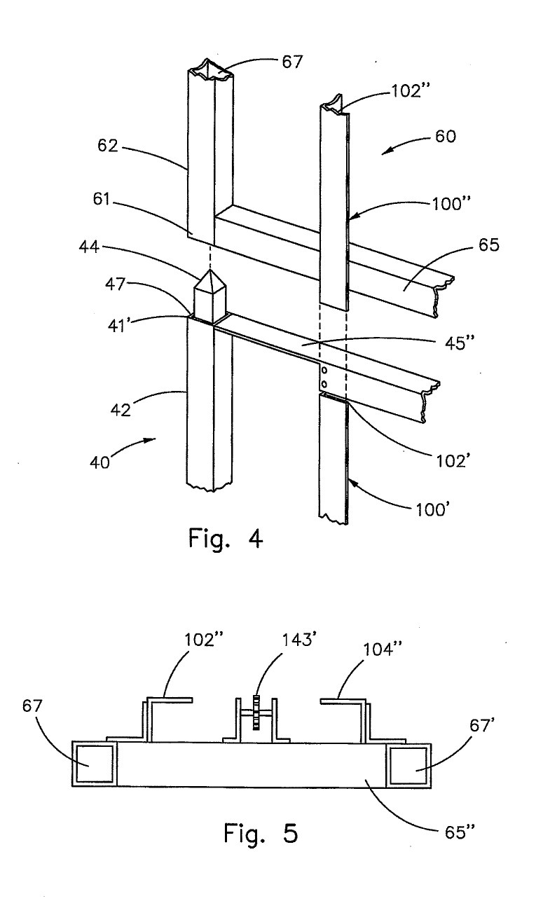

Lower frame assembly 20, in one of the embodiments shown in FIG. 3, has lower and upper ends 21 and 21′, respectively, with two elongated post members 22 and 22′, and bridging members 25; 25′; 26; 27; and 28. Members 22 and 22′ are affixed to a vertical wall surface S and disposed in a parallel and spaced apart relationship with respect to each other. Gussets 29 are mounted to surface S as seen in FIG. 3B. Elongated rigid bridging members 25; 25′; 26; 27; and 28 are disposed in a parallel and spaced apart relationship with respect to each other and extend perpendicularly from member 22 to member 22′ so that the distance between members 22 and 22′ remains uniform. At end 21, as best seen in FIG. 3A, post members 22 and 22′ include respective openings 23 and 23′ that receive and house a portion of pins 24 and 24′ in order to provide a mating part for members 42 and 42′, respectively. Lower frame assembly 20 also includes lower track assembly 100 mounted to bridging members 25′ and 27 and extending longitudinally along the entire length of assembly 20.

Middle frame assembly 40, in the embodiment, has ends 41 and 41′, with two elongated post members 42 and 42′, and bridging members 45; 45′; and 45″. Members 42 and 42′ are disposed in a parallel and spaced apart relationship with respect to each other. Elongated bridging members 45; 45′; and 45″ are disposed in a parallel and spaced apart relationship with respect to each other and extend perpendicularly from member 42 to member 42′ so that the distance between members 42 and 42′ remains uniform. End 41′ of post members 42 and 42′ include respective openings 47 that receive and house a portion of pins 44 in order to provide a mating part for members 62 and 62′, respectively. Middle frame assembly 40 also includes middle track assembly 100′ mounted to bridging members 45; 45′ and 45″. Depending on the structure where stackable frame dumbwaiter 10 is to be installed, the number of middle assemblies 40 may be varied depending on the number of floors to be serviced.

Upper frame assembly 60, in the embodiment, has ends 61 and 61′, with two elongated post members 62 and 62′, and bridging members 65; 65′; and 65″. Members 62 and 62′ are disposed in a parallel and spaced apart relationship with respect to each other. Elongated rigid members 65; 65′; and 65″ are disposed in a parallel and spaced apart relationship with respect to each other and extend perpendicularly from member 62 to member 62′ so that the distance between members 62 and 62′ remains uniform. At end 61′, post members 62 and 62′ include respective openings 67 and 67′ to provide a mating part for mounting members 62 and 62′. Upper frame assembly 60 also includes upper track assembly 100″ fixed to bridging members 65; 65′ and 65″.

Track assemblies 100; 100′; and 100″ correspond to lower, middle and upper sections and are longitudinally coextensive with assemblies 20; 40; and 60, as seen in FIG. 1. Track assemblies 100; 100′; and 100″ are welded to the frame assemblies; thus, limiting the assembly time of the system. Track assemblies 100; 100′; and 100″ have two elongated rail members 102 and 104; 102′; and 102″ and 104″, respectively, that are disposed in a parallel and spaced apart relationship with respect to each other. As best seen in FIG. 1, rail members 102; 104; 102′; 102″ and 104″ are L-shaped members, mounted to bridging members 25′; 27; and 28 of frame assemblies 20; 40; and 60, that allow dumbwaiter trolley 142 to move along vertically.

Dumbwaiter trolley 142 has U-shaped members 144 with cooperative dimensions to accept the inner portion of L-shaped members 102 and 104. End 141″ of drive chain 141 is mounted to dumbwaiter trolley 142 at upper end 142″. Drive chain 141 runs centrally along the vertical axis around sprocket 143′, mounted on member 65″ of upper frame assembly 60. Opposite end 141′ of drive chain 141 continues down the vertical axis and around sprocket 143, mounted on lower frame assembly 20, and is mounted to end 142′ of trolley 142. Dumbwaiter cart 140 is mounted to trolley 142 between supports 145 and 145′. Dumbwaiter cart 140 has cooperative dimensions to be mounted with fastening members between supports 145 and 145′.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1) A dumbwaiter comprising:
A) a lower frame assembly, at least one middle frame assembly, and an upper frame assembly, each of said frame assemblies having at least two vertically disposed elongated posts kept at a parallel and spaced apart relationship with respect to each other and at least one bridging member between said elongated posts mounted to an interior wall, and said frame assemblies being coaxially and continuously stackable within a central elongated through opening of a casing structure, said lower frame assembly including an electric motor means having driving sprocket means and control means having output means connected to said motor means;
B) track means longitudinally mounted to said bridging means of said lower, middle, and upper assemblies to cooperatively coaxially coincide as a continuous track means;
C) at least one input means remotely located from said electric motor means for selectively providing operational input signals to said control means;
D) wiring means for connecting said input means to said control means; said wiring means being mounted within said lower fame assembly and extendable to where said input means are located;
E) driven sprocket means removably mounted within said upper frame assembly;
F) chain means journeyed over said driving and driven sprocket means;
G) a dumbwaiter trolley slidably mounted to said track means and to said chain means for movement between two extreme positions within said central elongated through opening.

2. The dumbwaiter set forth in claim 1 wherein said control means includes input means mounted adjacent to, or within a relatively small distance from, said lower, middle, and upper frame assemblies.

3. The dumbwaiter set forth in claim 2 further including a safety circuit for interrupting the operation of said motor means upon the occurrence of at least one of a predetermined number of conditions.

4. The dumbwaiter set forth in claim 3 wherein said dumbwaiter trolley includes at least one U-shaped member that cooperatively receives said track means to guide said trolley.
